(19) United States
(12) Patent Application Publication
(10) Pub. No.: US 2009/0247916 A1
(43) Pub. Date: Oct. 1, 2009

(54) Massage chair

(75) Inventors: Daisuke Tsukada, Hikone (JP); Yuuichi Nishibori, Hikone (JP); Yoshiko Tsuji, Nagahama (JP); Takayoshi Tanizawa, Higashioumi (JP); Satoshi Kajiyama, Hikone (JP); Shouhei Taniguchi, Osaka (JP)

Correspondence Address: BACON & THOMAS, PLLC, 625 SLATERS LANE, FOURTH FLOOR, ALEXANDRIA, VA, 22314-1176, US

(73) Assignee: Panasonic Electric Works Co., Ltd., Kadoma-shi (JP)

(21) Appl. No.: 12/382,779

(22) Filed: Mar. 24, 2009

(30) Foreign Application Priority Data
Mar. 28, 2008 (JP) 2008-087877

(51) Int. Cl. A61H 7/00

(52) U.S. Cl. 601/84

(57) ABSTRACT

A massage chair includes a main seat portion; a backrest arranged at the rear of the main seat portion; and a seat surface length adjusting unit. The seat surface length adjusting unit includes an auxiliary seat portion extendible forwards from the main seat portion and a back-and-forth drive unit for moving the auxiliary seat portion forwards and backwards to change a front-to-back length of a seat surface. The massage chair further includes a footrest rotatably attached to the auxiliary seat portion, the footrest being movable forwards and backwards together with the auxiliary seat portion.

### FIELD OF THE INVENTION

The present invention relates to a massage chair and, more specifically, to an improved massage chair capable of enabling a user to snugly and deeply sit on a seat portion with an increased front-to-back length and providing an enhanced relaxation effect.

### BACKGROUND OF THE INVENTION

Conventionally, a massage chair including a seat portion and a backrest arranged at the rear of seat portion is well-known (see, e.g., Japanese Patent Laid-open Publication No. H-10-295758). The massage chair is sized such that everybody can sit on it. In fact, users of the massage chair have different body sizes. When a user takes a seat in the posture as illustrated in FIG. 4A, the width D between the waist and the bottoms of the feet and the width E between the waist and the knees are different from user to user. In reality, the size of the massage chair does not fit to the body sizes of all sorts of people. Therefore, it is often the case that the feet are positioned away from a footrest 7 when a user with a big body leans on a backrest 4 as shown in FIG. 4B.

As a solution to this problem, it may be contemplated to increase the front-to-back length B of a seat portion 2′ so that a gap F should not be created between the feet of a big user and the footrest 7, thus enabling the user to put his or her feet on the footrest 7. In case of a little user or an old user, however, it is necessary to correct his or her sitting posture several times in an effort to deeply sit on the seat portion 2′ with an increased front-to-back length. This is problematic in that the user may feel inconvenient when sitting on and standing up from the seat portion 2′.

### SUMMARY OF THE INVENTION

In view of the above, the present invention provides a massage chair in which the front-to-back length of a seat surface is adjustable to enable a user to sit on or stand up from the seat surface in a convenient manner, while allowing the user to deeply sit on the seat surface with an increased front-to-back length.

In accordance with an aspect of the present invention, there is provided a massage chair including:

a main seat portion;

a backrest arranged at the rear of the main seat portion; and

a seat surface length adjusting means including an auxiliary seat portion extendible forwards from the main seat portion and a back-and-forth drive unit for moving the auxiliary seat portion forwards and backwards to change a front-to-back length of a seat surface.

With this configuration, the auxiliary seat portion is stored within the main seat portion to shorten the front-to-back length of the seat surface when the chair is left empty. This makes it easy for a user to deeply sit on the seat surface whose front-to-back length is kept small at the sitting time. Once the user takes a seat, the auxiliary seat portion is drawn forwards from the main seat portion to increase the front-to-back length of the seat surface. This enables the user to enjoy back massage with a pleasant feeling in a state that the user snugly and deeply sits on the seat surface having an increased front-to-back length. When the user leaves the chair, the auxiliary seat portion is stored within the main seat portion to shorten the front-to-back length of the seat surface again. This makes it possible for the user to stand up from the seat portion in a convenient manner.

Preferably, the footrest is rotatably attached to the auxiliary seat portion so that it can move forwards and backwards together with the auxiliary seat portion. This makes it possible to bring the user's feet into close contact with the footrest while allowing the user to deeply sit on the seat surface with an increased front-to-back length. Therefore, it becomes possible to relieve the efforts which would otherwise be required in adjusting the back-and-forth position of the footrest when changing the front-to-back length of the seat surface.

With the present invention, the front-to-back length of the seat surface can be adjusted by extending or retracting the auxiliary seat portion with respect to the main seat portion. This enables the user to deeply sit on the seat surface having an increased front-to-back length in a seated state. Even if the user is a little person, an old person, a handicapped person or a person suffering from lumbago or rheumatism, it is possible for the user to sit on or stand up from the seat surface in an easy and convenient manner.

### BRIEF DESCRIPTION OF THE DRAWINGS

The objects and features of the present invention will become apparent from the following description of embodiments, given in conjunction with the accompanying drawings, in which:

FIG. 1A is a schematic side section view showing a massage chair provided with a seat surface length adjusting unit in accordance with one embodiment of the present invention, and FIG. 1B is a plan view thereof;

FIG. 2 is a schematic side section view illustrating a state in which a user sits on a seat surface whose front-to-back length is increased by extending the auxiliary seat portion forwards with the seat surface length adjusting unit;

FIG. 3 is a schematic side section view illustrating an operation by which the knees are lifted up to prevent the backs of the knees from being caught in the massage chair when the auxiliary seat portion is retracted; and

FIG. 4A is a view for explaining one example of a body size, and FIG. 4B is a side view illustrating a state in which a big person sits on a conventional massage chair.

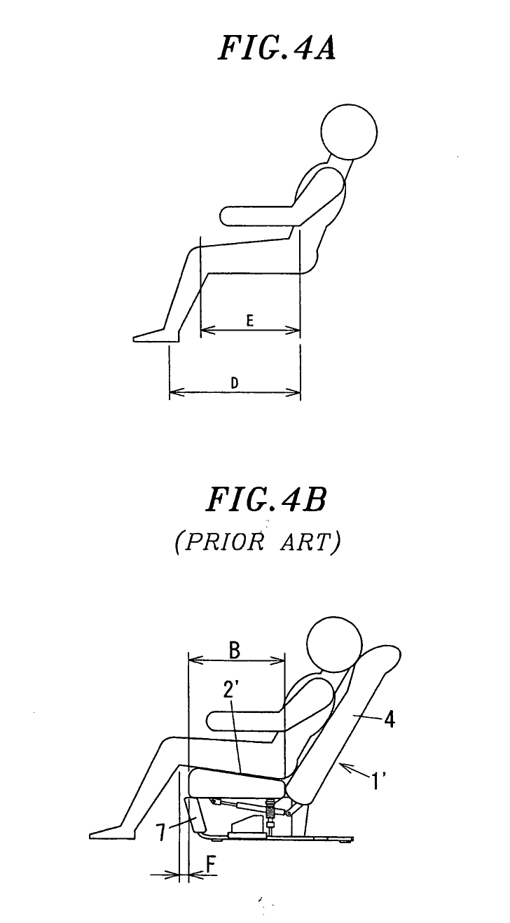

### DETAILED DESCRIPTION OF THE PREFERRED EMBODIMENTS

Hereinafter, an embodiment of the present invention will be described with reference to the accompanying drawings.

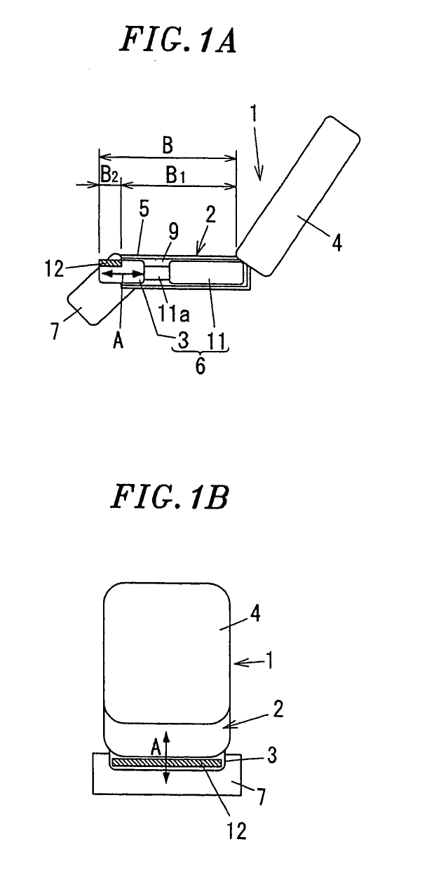

Referring to FIGS. 1A and 1B, a massage chair 1 of the present embodiment includes a main seat portion 2 on which a user sits, a backrest 4 arranged at the rear of the main seat portion 2 and a footrest 7 on which the user's feet are put. Armrests (not shown) are arranged at the opposite sides of the main seat portion 2. The backrest 4 is equipped with a massage mechanism (not shown) for performing, e.g., kneading, slapping and other massaging actions. Alternatively, the massage mechanism may be provided in the main seat portion 2 or the footrest 7.

The main seat portion 2 is fixed to and supported by a chair frame (not shown). A hollow storage portion 9 opened forwards is provided inside the main seat portion 2. An auxiliary seat portion 3 and a back-and-forth drive unit 11 for moving the auxiliary seat portion 3 forwards and backwards, both of which constitute a seat surface length adjusting unit 6, are accommodated within the storage portion 9.

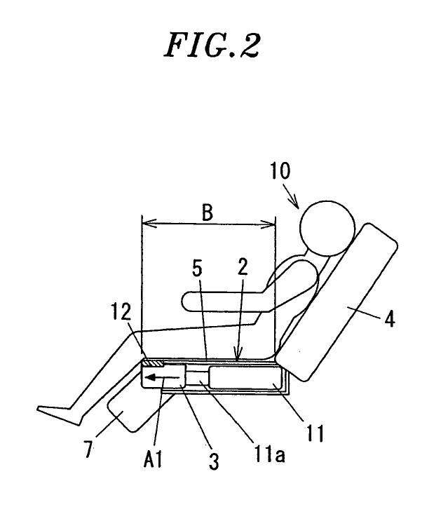

The auxiliary seat portion 3 is extendible forwards of the main seat portion 2. The front-to-back length B2 of the auxiliary seat portion 3 protruding from the main seat portion 2 is shorter than the front-to-back length B1 of the main seat portion 2. The vertical thickness of the auxiliary seat portion 3 is a little smaller than that of the main seat portion 2. The auxiliary seat portion 3 is substantially the same as the main seat portion 2 in terms of the width and the material. On the upper surface of a front half of the auxiliary seat portion 3, a band-shaped air cell 12 is provided to extend over the full width of the auxiliary seat portion 3. The air cell 12 is inflated or collapsed as an air is supplied to or discharged from the same. By inflating the air cell 12 with the auxiliary seat portion 3 extended forwards (as indicated by an arrow A1 in FIG. 2), it is possible to reduce or eliminate the step difference which would otherwise be created between the upper surface of the auxiliary seat portion 3 and the seat surface 5 of the main seat portion 2.

The back-and-forth drive unit 11 includes, e.g., a telescopic actuator 11a, such as an air cylinder or the like, for moving the auxiliary seat portion 3 forwards and backwards (as indicated by an arrow A in FIGS. 1A) by its extension and retraction operation. In other words, the auxiliary seat portion 3 is moved forwards and backwards by the extension and retraction operation of the telescopic actuator 11a.

In the present embodiment, the massage chair includes a detector unit (not shown) for detecting the start and end of a massage operation performed by the massage mechanism and a control unit (not shown) for controlling the telescopic actuator 11a and the air cell 12 in response to a signal supplied from the detector unit. If the start of the massage operation is detected, the telescopic actuator 11a is extended and an air is supplied to the air cell 12. When the end of the massage operation is detected, the air is discharged from the air cell 12 and the telescopic actuator 11a is retracted.

The footrest 7 on which the feet of the user 10 are put is rotatably attached to the side surfaces of the auxiliary seat portion 3. As the auxiliary seat portion 3 is moved forwards and backwards, the footrest 7 moves together with the auxiliary seat portion 3.

Next, description will be made on how to use the massage chair 1 of the present embodiment.

When the massage chair 1 is left empty, the telescopic actuator 11a remains retracted and the auxiliary seat portion 3 is stored within the main seat portion 2. Thus the front-to-back length B1 of the seat surface 5 is kept short. When taking a seat, the user can deeply sit on the main seat portion 2 by merely standing in front of the main seat portion 2 and then bending the user's knees.

If a massage operation is started in the seated state, the telescopic actuator 11a is extended to cause the auxiliary seat portion 3 to protrude forwards from the main seat portion 2 as indicated by an arrow A1 in FIG. 2, thereby increasing the overall front-to-back length of the seat surface 5 to B (=B1+B2). Simultaneously, an air is supplied to the air cell 12 of the auxiliary seat portion 3 to inflate the same, which makes the seat surface 5 flush in its entire area (as shown in FIG. 2). At this time, the footrest 7 moves forwards together with the auxiliary seat portion 3. This makes it possible to relieve the efforts which would otherwise be required in adjusting the back-and-forth position of the footrest 7. Therefore, the user can snugly and deeply sit on the seat surface 5 with the increased front-to-back length B. The back-and-forth unitary movement of the footrest 7 and the auxiliary seat portion 3 makes it possible to bring the user's feet into close contact with the footrest 7. This can satisfy both the massage effect provided by the backrest 4 and the foot support effect provided by the footrest 7.

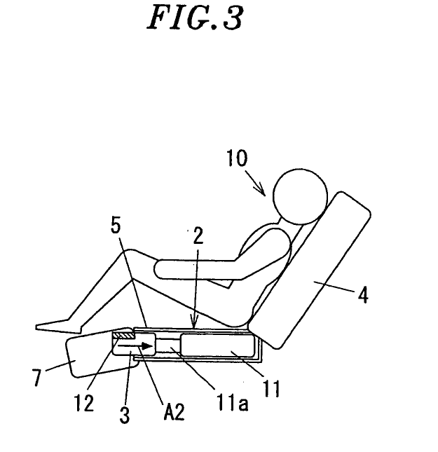

If the end of the massage operation is detected, the air is discharged from the air cell 12 and the telescopic actuator 11a is retracted to store the auxiliary seat portion 3 within the main seat portion 2. This enables the user to stand up in an easy and convenient manner, with the bottoms of the user's feet placed on a floor. When moving the auxiliary seat portion 3 backwards as indicated by an arrow A2 in FIG. 3, the footrest 7 is caused to move upwards to thereby lift up the knees from the seat surface 5. Thereafter, the auxiliary seat portion 3 is moved backwards. This makes it possible to prevent the backs of the knees from being caught in the massage chair 1 and, consequently, to enhance safety when the user stands up from the massage chair 1.

As described above, when in a seated state, the user can snugly and deeply sit on the seat surface 5 with the increased front-to-back length B. During the course of sitting down or standing up, it is possible to reduce the front-to-back length B of the seat surface 5. Therefore, even if the user is a little person, an old person, a handicapped person or a person suffering from lumbago or rheumatism, it is possible for the user to sit on or stand up from the seat surface 5 in an easy and convenient manner. Furthermore, one kind of massage chair 1 can provide the seat surface 5 having variable front-to-back length B. This makes the massage chair 1 highly economical. In addition, the front-to-back length B of the seat surface 5 can be kept short when the massage chair 1 is left empty. This makes it possible to store the massage chair 1 in a compact form.

Although the telescopic actuator 11a has been described as an example of the back-and-forth drive unit 11, it may be possible to use, e.g., a reversible motor in place thereof. Furthermore, although the above description is directed to a case where the back-and-forth drive unit 11 and the air cell 12 are automatically controlled by detecting the start and end of the massage operation. The present invention is not limited thereto. Alternatively, the back-and-forth drive unit 11 and the air cell 12 may be independently operated by the user using an operation unit provided within reach of the user's hand in a seated state.

While the invention has been shown and described with respect to the embodiments, it will be understood by those skilled in the art that various changes and modification may be made without departing from the scope of the invention as defined in the following claims.

What is claimed is:

1. A massage chair comprising:
a main seat portion;
a backrest arranged at the rear of the main seat portion; and
a seat surface length adjusting unit including an auxiliary seat portion extendible forwards from the main seat portion and a back-and-forth drive unit for moving the auxiliary seat portion forwards and backwards to change a front-to-back length of a seat surface.

2. The massage chair of claim 1, further comprising a footrest rotatably attached to the auxiliary seat portion, the footrest being movable forwards and backwards together with the auxiliary seat portion.

3. The massage chair of claim 1, further comprising an air cell provided on an upper surface of the auxiliary seat portion.

4. The massage chair of claim 1, wherein the back-and-forth drive unit moves the auxiliary seat portion forwards at the beginning of a massage operation and backwards at the end of the massage operation.

5. The massage chair of claim 3, wherein an air is supplied to the air cell at the beginning of a massage operation and the air is discharged from the air cell at the end of the massage operation.

6. The massage chair of claim 4, wherein an air is supplied to the air cell at the beginning of a massage operation and the air is discharged from the air cell at the end of the massage operation.
